(19) United States
(12) Patent Application Publication
(10) Pub. No.: US 2009/0009289 A1
(43) Pub. Date: Jan. 8, 2009

(54) Cattle identification system employing infra-red tag and associated tag reader

(76) Inventor: Barrington Simon, Ancaster (CA)

Correspondence Address: Barrington L Simon, 717 Woodhaven, Ancaster, ON, L9G 5B1, CA

(21) Appl. No.: 11/773,478

(22) Filed: Jul. 5, 2007

(51) Int. Cl. H04B 7/00

(52) U.S. Cl. 340/10.1

(57) ABSTRACT

The invention relates to a method of identifying an animal within a group, the method of identification being characterized by the steps of: attaching an identification device—an electronic tag—to the animal, locating an activation device—a tag reader—at a location, and activating an indicator when the identification device within a range of the activation device.

### FIELD OF THE INVENTION

This invention relates to a method and associated apparatus for domestic and wild animal remote monitoring that also allows preventing and eradicating of animal diseases. More particularly, this invention relates to cattle identification and monitoring method and associated devices, including an infra-red electronic tag and a reader, for carrying out the method.

### BACKGROUND OF THE INVENTION

This application is the corresponding non-provisional one related to Provisional Application No 60/766808.

The conventional tags that are used today for cattle identification is a visual tags, such as ear tags produced by Ketchurn Manufacturing Inc. containing ID number or/and barcode. These tags require manual reading and data entry. Although it is possible to use manual identification methods for livestock and to employ manual data entry methods, it is desirable to automate the identification and data entry in order to reduce expense and to improve accuracy of the data. These devices typically produce either a unique alphanumeric code or a unique decimal code. Such devices, electronic identification devices and systems, have provided a good method for providing identification of livestock. Typically, electronic identification systems utilize a passive electronic identification device that is induced to transmit its identification signal by an externally radiating source.

One of such systems, the system utilizing an RF electronic tag and tag reader, is produced by Temple Tag Ltd.

All tags provide livestock PIN number, history and performance information. All information is coded as barcode (for visual tag), or as sequence of RF pulses sent by RF tag when it activated.

### SUMMARY OF THE INVENTION

According to one aspect of the present invention there is provided a method of identifying an animal within a group, characterized by the steps of:

a) attaching an identification device to an animal, and

b) locating an activation device at a location, and

c) activating an indicator when the activation device is directed to the animal equipped with the identification device.

According to another aspect of the present invention there is provided apparatus for a method of identifying an animal substantially as described above, wherein the identification system comprises an identification device—an electronic tag—attached to an animal and an activating device—the tag reader having an indicator and equipped with an optical sight. In a preferred embodiment of the present invention the tag reader and the identification device contain infra-red transmitter and receivers. Therefore, being activated, the identification device emits an infra-red response signal.

Other embodiments may use another technology, such as devices which emit different frequencies of electromagnetic energy, not necessarily in the infra-red range. For example, other embodiments may use identification devices which emit visible light signals or even audible sound signals.

### DETAILED DESCRIPTION OF THE PREFERRED EMBODIMENTS OF THE INVENTION

The monitoring system comprises an identification device—an electronic tag—attached to an animal and an activating device—the tag reader having an indicator.

This tag, being activated by direct infra-red (IR) beam pointing the monitored animal by means of the optical sight, provides sequences of optical pulses containing the information about the animal. These pulses are received by the reader that displays the information on LED or LCD screen and stores it in memory. These data further are transmitted to central computer to create history of the animal. The distance of this device can reach tens of meters, so the person can stay away from the animal activating the tag of the pointed animal.

The schematic diagram of this system is depicted in FIG. 1.

The system consists of the miniature optical ear tag 1 and receiver (reader) 2. The tag 1 contains transmitter 3 emitting IR signal, IR receiver 4, electronic chip (processor) 6, memory 6 and lithium battery 7.

The reader 2 contains optical sight 16 aligned with transmitter 10 emitting IR signal, optical receiver 9, electronic chip (processor) 11, memory 15, display screen 12, USB port 14 and lithium battery 13.

The system operates as follows:

The tag reader 2 is directed to the monitored animal by the optical sight 16. Being activated, the reader 2 sends short optical pulse emitted by the transmitter 10 that is received by the receiver 4 of the tag 1. It activates electronics (processor 6) of the tag 1, which start transmitting the data stored in the memory 6 via optical line 8 provided by the transmitter 3 of the tag 1 and the receiver 9 of the reader 2. This information is processed by the processor 11 of the reader 2, displayed on the screen 12 and stored in the memory 15 of the reader 2. Further, this information can be transmitted to any computer via USB port 14. The information stored in the memory 6 of the tag 1 can be updated via the same optical line 8 using specially organized sequence of optical pulses emitted by the transmitter 10 of the reader 2.

The transmitters and receivers of the tag 1 and reader 2 can work in near IR—about 1500 nm—that is eye-safe. The distance of the transmission is reaches tens of meters; it depends on power and angular width (divergence) of the beam that can be adjustable (according to safety requirements) and customized according to request.

Additionally, the tag could be equipped with health-monitoring devices whose data can be further transmitted to the reader via the optical line 8.

Also, the tag can be moved from one animal to another one. In this case, the memory 6 has to be rewritten by the reader 2 via the optical line 8.

### DRAWINGS

FIG. 1 depicts diagram of the preferred embodiment of the present invention—cattle identification system utilizing an infra-red tag and associated tag reader.

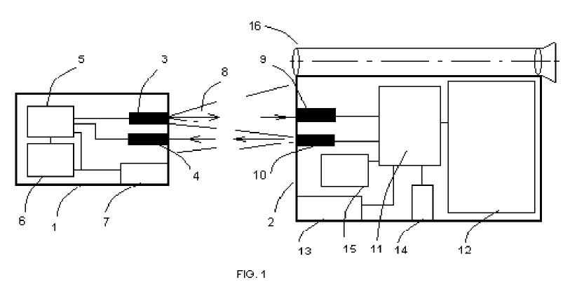

What is claimed is:

1. A method of identifying a livestock animal within a group, characterized by the steps of:
a) attaching an identification device to a livestock animal within the group, and
b) locating an activation device at a location, and
c) activating the identification device when it is directed to and within a range of the activation device,
wherein the identification device will transmit identification information to the activation device.

2. An identification system, for identifying a livestock animal within a group, wherein the identification system includes:
a) an identification device attached to an animal, wherein the identification device is an electronic tag containing a memory chip, infra-red transmitter and receiver, and
b) an activation device—a tag reader—containing an optical sight, a memory chip, LCD screen, an infra-red transmitter and receiver, wherein said activating device sequentially activates the identification device, receives identification information from the identification device, displays it on the LCD screen and stores in the memory.
